(19) United States
(12) Patent Application Publication
(10) Pub. No.: US 2011/0231289 A1
(43) Pub. Date: Sep. 22, 2011

(54) METHOD AND SYSTEM FOR TRANSACTION OF SPORT INFORMATION

(76) Inventor: YI-TSUNG LIU, TAICHUNG CITY (TW)

(21) Appl. No.: 12/726,592

(22) Filed: Mar. 18, 2010

(51) Int. Cl. G06Q 50/00; G06N 5/02; G06Q 30/00; G06Q 20/00

(52) U.S. Cl. 705/27.1; 706/52; 463/25

(57) ABSTRACT

A method is applied in a transaction system for transaction of sport information among information seller and buyer, and the transaction center so as to result in paying a transaction fee. The buyer operates a first electronic device to fetch a selection chart and personal data of an individual seller, and transmits a transaction signal to a transaction module. After completing each transaction, a website module transmits a prediction result of a coming match to a second electronic device, hence the buyer.

### BACKGROUND OF THE INVENTION

1. Field of the Invention

The present invention relates to a transaction system and method, more particularly to a transaction system and method for sport information exchange and paying a transaction fee thereby.

2. Description of the Prior Art

In Taiwan, sport lottery comes into being since 2008 so that sport fans can bet legally on sport matches relying on their favorite sport team. It is noted that a portion of the earning form the sport lottery goes to the charity foundations or trust and since that portion is relatively large in amount and therefore has helped many of the poor communities.

Regarding selection of the numbers for betting in a lottery, a great deal of effort is needed for analyzing the pros and cons of winning prizes in the lottery. In the past, several match analysis for the coming matches are broadcasted over some websites for the lottery buyers. Moreover, some sport analyzers provide prediction results for the coming matches over some websites or sport centers.

As a result, though the betting persons can obtain the prediction result from the above-stated websites or sport centers, it is often found that the prediction result is not reliable and there is no standard of accuracy for the prediction result such that the prediction result often bring negative effect.

In addition, the sport analyzers have devoted a tremendous effort to conduct the sport analysis, but he yields no actual profit in return.

### SUMMARY OF THE INVENTION

As mentioned above, in the past though the betting persons can obtain the prediction result from the websites or sport centers, it is often found that the prediction result is not reliable and there is no standard of accuracy for the prediction result such that the prediction result often bring negative effect.

In addition, the sport analyzers have devoted a tremendous effort to conduct the sport analysis, but he yields no actual profit in return.

Therefore, the object of the present invention is to provide a transaction method adapted to be applied in a sport transaction center for transaction of sport information among a sport information seller, a sport information buyer and the sport transaction center so as to result in paying a transaction fee.

The other object of the present invention is to provide a transaction system, where transaction of sport information between a sport information seller and a sport information buyer can be conducted.

The transaction method is adapted to be applied in a transaction system for transaction of sport information between a sport information seller and a sport information buyer so as to result in paying a transaction fee. The transaction method accordingly includes the steps of:

(a) the information seller, relying on a sport match broadcasted over a website module, operating a first electronic device to transmit a prediction result of the sport match and the transaction fee to the website module;

(b) the information buyer operating a second electronic device to transmit a match selection signal to the website module so as to select the sport match;

(c) the second electronic device transmitting a selection condition data to the website module such that a selection module generates a selection chart depending on the selection condition data, the selection chart including a personal data of an individual information seller and the transaction fee, wherein the individual information seller being corresponding to the information seller;

(d) the information buyer, depending on the selection chart, operating the second electronic device to transmit a seller-selection signal to the website module in order to choose the personal data of the individual information seller within the selection chart;

(e) the information buyer operating the second electronic device to transmit a transaction signal to the website module such that a transaction module conducts a transaction in response to the transaction signal, thereby completing paying the transaction fee;

(f) the website module transmitting the prediction result of the sport matches to the second electronic device, hence the information buyer;

(g) the sport transaction system remitting a partial amount of the transaction fee to the information seller; and

(h) upon finishing of the sport match, the sport transaction system, depending on a result of the sport match and in case the prediction result matches with the result, using a compiling module to raise percentage of betting rate of the information seller.

A transaction system of the present invention is applied for conducting transaction of a transaction fee via the Internet which is coupled electrically to a first electronic device and a second electronic device. The transaction system of the present invention accordingly includes a website module, a compiling module, a selection module and a transaction module.

The website module is used for broadcasting a sport match and receiving, prior to beginning of the sport match, a prediction result of the sport match transmitted by a sport information seller via the first electronic device and a match selection signal and a selection condition data transmitted by an information buyer via a second electronic device.

The compiling module is coupled electrically to the website module for raising a percentage of betting rate of the information seller when the prediction result matches with a result of the sport match.

The selection module is coupled electrically to the website module for generating a selection chart depending on the selection condition data, the selection chart including a personal data of an individual information seller.

The transaction module is coupled electrically to the website module for conducting the transaction, thereby completing paying the transaction fee.

After the information buyer chooses the personal data of the individual information seller within the selection chart, a transaction signal is transmitted to the transaction module for completing paying the transaction fee and the prediction result of the sport match is transmitted to the second electronic device.

When compared with the prior art, because the percentage of betting rate of the information seller is disclosed over the website, the information buyer can make a proper decision when filling the selection condition data and paying the transaction fee, thereby obtaining the prediction result of the coming sport match. Depending on the prediction result, the information buyer can bet on the sport lottery and yields some benefit therefrom.

In addition, the sport analyzers (i.e. the information seller) can get the due reward, since a preset amount of the transaction fee is remitted to the information seller by the sport transaction center upon receipt of the transaction fee paid by the information buyer after he had received the prediction result of the coming sport match.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a block diagram representing a transaction system of the present invention;

FIG. 2 shows a block diagram illustrating how a registration signal and an entering signal are transmitted to the transaction system of the present invention;

FIG. 3 is a display screen of a website module of the transaction system of the present invention showing a sport match content;

FIG. 4 shows the display screen of FIG. 3 in a simulated prediction mode;

FIG. 5 shows the display screen of FIG. 3 in a real prediction mode;

FIG. 6 shows the display screen of FIG. 3, into which a selection condition data is inputted by a sport information buyer according to the present invention;

FIG. 7 illustrates a display screen of the website module in the transaction system of the present invention after input of the selection condition data;

FIG. 8 shows a display screen of the website module illustrating the content when no selection condition data is inputted;

FIG. 9 shows the display screen of the website module waiting for inputting of entry code to be inserted by a sport information buyer according to the present invention;

FIG. 10 shows the display screen of the website module illustrating how the information buyer fetches a prediction result of a coming match according to the present invention;

FIG. 11 shows the display screen of the website module illustrating how an information seller input a verifying code for access into the website module according to the present invention; and

FIGS. 12 and 12A respectively show the block diagram illustrating the steps for a transaction method of the present invention for conducting a transaction fee.

### DETAILED DESCRIPTION OF THE PREFERRED EMBODIMENT

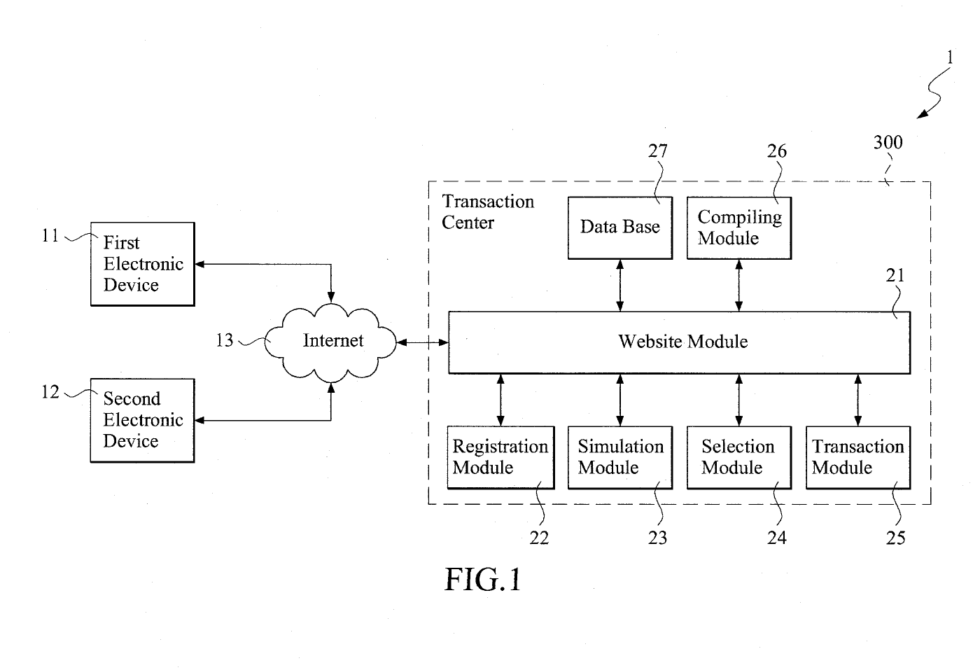

FIG. 1 shows a block diagram representing a transaction system of the present invention and is adapted to be applied in a sport transaction center for transaction of sport information via the Internet among a sport information seller, a sport information buyer and the sport transaction center so as to result in paying a transaction fee by the information buyer. As illustrated, the transaction system 1 of the present invention includes a first electronic device 11, a second electronic device 12 and a sport transaction center 300. The first and second electronic devices 11, 12 are coupled electrically to the Internet 13, which, in turn, is electrically coupled to the sport transaction center 300, wherein the first and second electronic devices 11, 12 can be PCs (personal computer) or mobile phones. The sport transaction center 300 includes a website module 21, a registration module 22, a simulation (prediction) module 23, a selection module 24, a transaction module 25, a compiling module 26 and a data base 27.

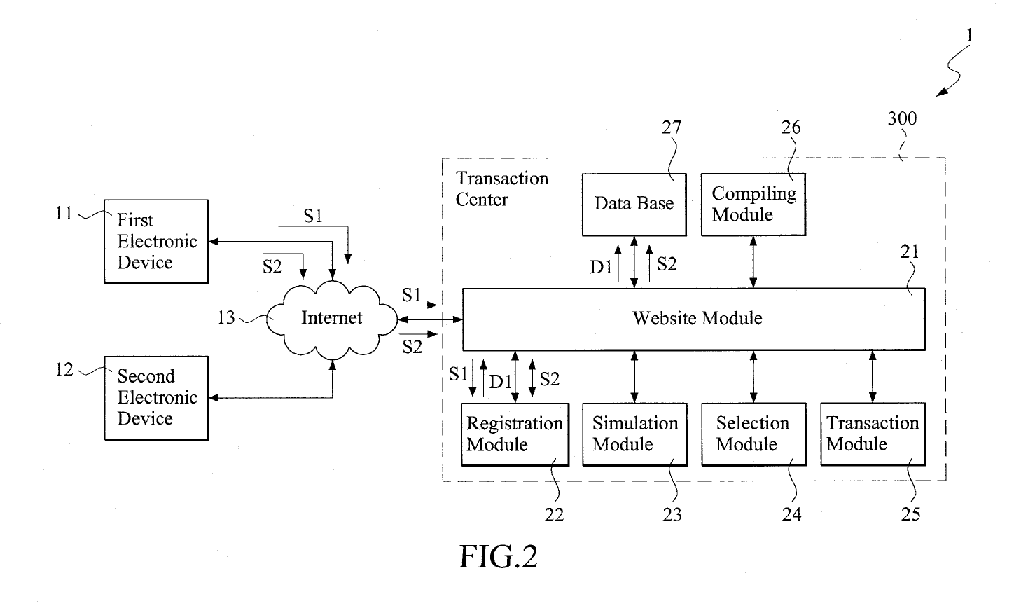

The website module 21 is coupled electrically to the Internet 13, the registration module 22, the simulation module 23, the selection module 24, the transaction module 25, the compiling module 26 and the data base 27. The website module 21 is used for broadcasting a sport match and, prior to beginning of the d sport match, capable of receiving a registration signal S1 and an entry signal S2 (see FIG. 2) [containing simulated prediction data, a prediction result of the sport match and a transaction fee] transmitted by a sport information seller via the first electronic device 11 and a selection signal, a selection condition data, and a verifying code transmitted by an information buyer via the second electronic device 12.

The registration module 22 generates a registration data D1 in response to the registration signal S1 and stores the registration data D1 within the data base 27 (see FIG. 2). The compiling module 26 is used for raising a percentage of betting (accuracy) rate of the information seller only when the prediction result transmitted by the first electronic device 11 matches with a result of the sport match. The selection module 24 is used for receiving the selection condition data transmitted by the second electronic device 12 and comparing the same relative to the registration data D1 within the base data 27, and afterward generates a selection chart depending on the selection condition data. The transaction module 25 is used for executing the transaction signal, thereby conducting the transaction and completing paying the transaction fee. The simulation module 23 compares the result of the sport match relative to a simulated prediction data transmitted by the first electronic device 11 such that in case the result of the sport match matches with the simulated prediction data, the compiling module 26 raises the percentage of betting rate of the information seller.

Referring to FIG. 2, when the information seller operates the first electronic 11 to transmit the registration signal S1 to the website module 21 via the Internet 13, the website module 21 transfers the registration signal S1 to the registration module 22, wherein the registration signal S1 includes a coded account, a contact method, a verifying code and a remittance account. The contact method may include numbers of mobile phones and e-mail addresses. The registration module 22 in response to the registration signal S1 registers the registration data D1 of the information seller in the transaction center 300 and stores the data in the data base 27, thereby becoming a member thereof. Thus, the registration data D1 includes the coded account, the contact method, the verifying code, the remittance account, the percentage of betting rate of the information seller, the personal data of an individual information seller, the number representing the information seller.

In addition, the information seller operates the first electronic device 11 to transmit an entering signal S2 to the website module 21 and enters the transaction center 300. The entering signal S2 may include the coded account of the corresponding information seller. The website module 21 transmits the signal S2 to the registration module 22, where the registration module 22 compares the signal S2 relative to the registration data D1 within the data base 27. The registration module 22 permits access of the information seller to the transaction center 300 when the coded account of the signal S2 is found within the registration data D1.

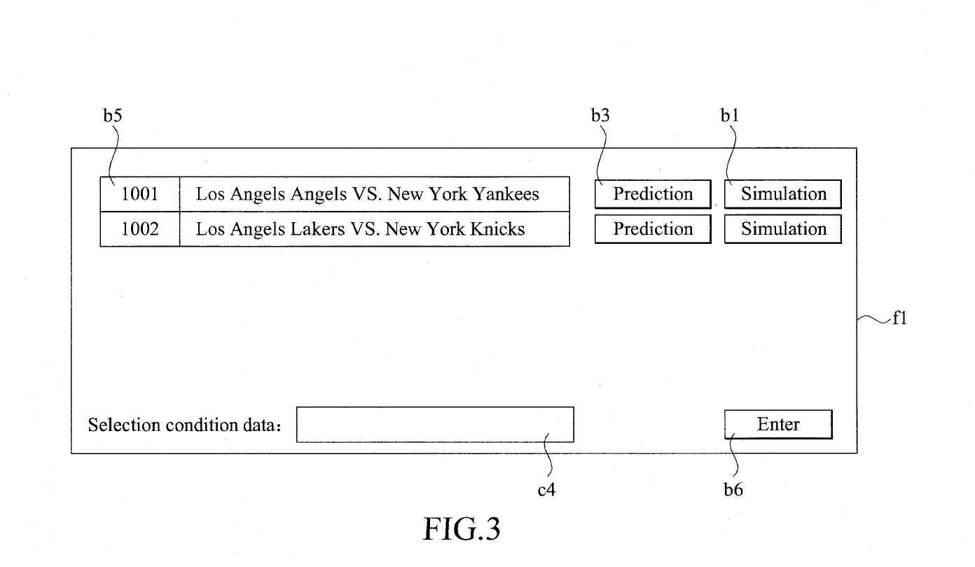

FIG. 3 is a display screen f1 of the website module 21 of the transaction system 1 of the present invention showing a sport match content. Upon access to the transaction center 300 and the information seller chooses either the real prediction mode or the simulated prediction mode in the website module 21.

In another embodiment, after access into the transaction center 300, the website module 21 determines, depending on the percentage of betting (accuracy) rate of the information seller, whether to permit the information seller input of the real prediction mode. In case, the percentage of the betting rate of the information seller is greater a specific index, it is determined that the information seller has already accumulated a predetermined amount of experience concerning predicting the sport matches. Under this condition, the information seller is permitted to input the real prediction mode, thereby providing the information buyer a more accurate prediction result for the coming matches.

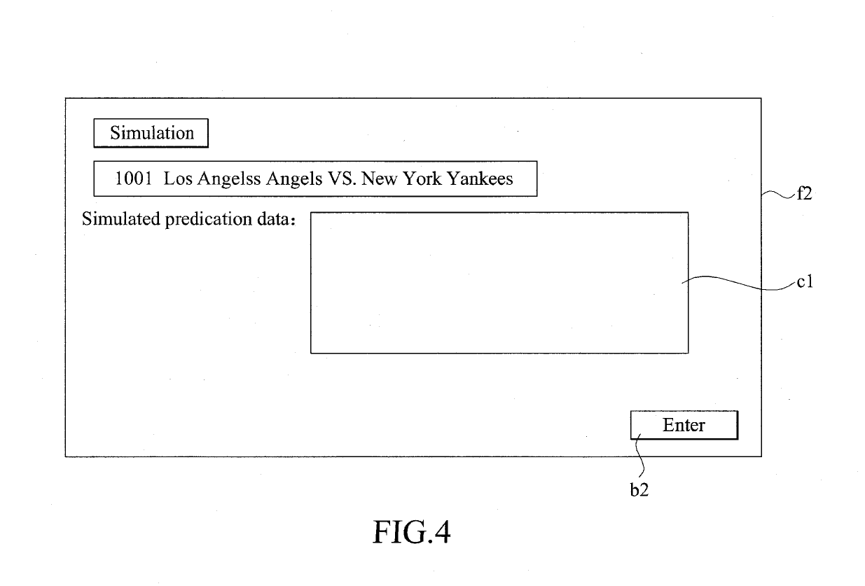

Referring again to FIG. 3, when the information seller selects a simulated block b1 in response to a sport match broadcasted by the website module 21, he is in the simulated prediction mode. FIG. 4 shows the display screen f2 of the website module in the simulated prediction mode. The information seller can insert the simulated prediction data into a simulated prediction column c1, and can press the enter button b2 for confirmation, thereby transmitting the simulated prediction data to the website module 21, which, in turn, transmit the same to the simulation module 23. Upon completion of the sport match, the simulation module 23 compares the simulated prediction data relative to the result of the sport match and raises the percentage of the betting rate of the information seller when the simulated prediction data matches with the result of the sport match. The increased percentage of the betting rate is transmitted to the website module 21, which, in turn, conveys the same message to the compiling module 26.

For instance, the sport match is a baseball match between first and second teams (as shown in FIG. 3; Los Angeles Angels vs. New York Yankees). The information buyer selects the simulated button b1 of the match number 1001 (Los Angeles Angels vs. New York Yankees), inputs “Yankees win” in the simulated prediction column c1 and presses the entry button b2 for confirmation, thereby transmitting the simulated prediction data to the simulation module 23. Upon completing of the baseball match and in case the Yankee wins, the compiling module 26 will raise the percentage of betting rate of the information seller.

Note that the percentage of betting rate includes precision data and a yielding data. The precision data preferably includes a real prediction data and a simulated precision data. The yielding data preferably includes a real yielding data and a simulated yielding data.

The larger the numbers of the simulated precision data, the simulated yielding data, the real precision data and the real yielding data become the greater the values of the simulated precision data, the simulated yielding data, the real precision data and the real yielding data for the information seller. In other words, the sport analyzer (the information seller) can provide a better accuracy of the coming matches. Under this condition, the sport analyzer can demand a higher transaction fee for supplying of the prediction result of the coming matches.

The simulated precision data is calculated as follows. For instance, the sport analyzer transmits the simulated prediction data to the transaction center 300 for ten times, wherein eight pieces of the simulated prediction data match with the results of the sport matches respectively. Under this condition, the simulated precision data is (8÷10×100%); i.e., 80% of simulated precision rate.

The simulated yielding data is calculated as follows. Those banks distributing the sport lottery have set out different compensation rates for different types of the lottery. For instance, the bank has announced that if Yankees win, the compensation rate is 1.8; i.e., if the information buyer bets 100$ on the sport match, and if the Yankees win, the information buyer will get 180$. In this embodiment, the sport analyzer has transmitted the prediction result to the transaction center 300 for 10 times, wherein 8 times match with the results of the sport matches respectively. Under this condition, the betting total amount is 1000$ and after all the matched are played, he yields a total amount of 1440$. Subtracting 1000$ from 1440$, the simulated yielding rate of the sport analyzer is 44%=(1440−1000)÷1000×100%.

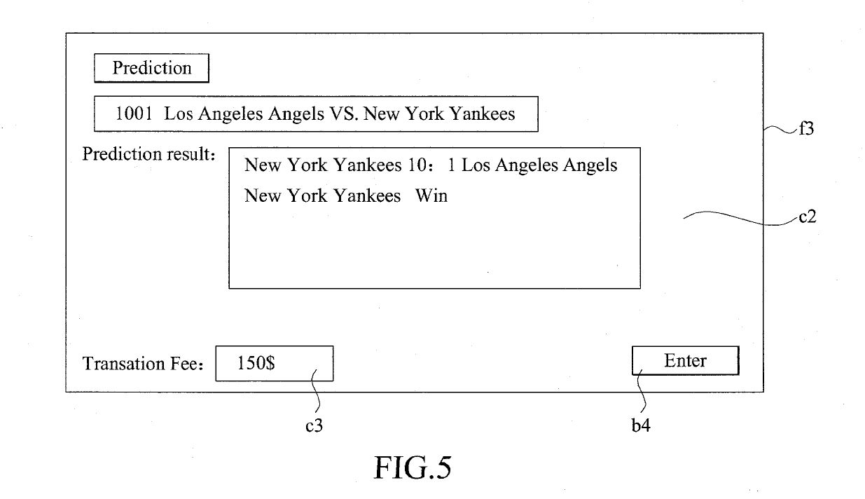

Referring again to FIG. 3, in case the sport analyzer the chooses a prediction button b3 in response to the sport match broadcasted by the website module 21, he is in the real prediction mode. FIG. 5 shows the display screen f3 of the website module 21 in the real prediction mode, where the information seller inputs “the prediction result” and “the transaction fee” into the prediction column c2 and the transaction fee column c3 respectively and he presses the enter button b4 for confirmation, thereby transmitting “the prediction result” and “the transaction fee” to the website module 21. Note that in order to maintain fair transaction, the transaction fee demanded by the information seller must be compatible with the lowest transaction fee laid out by the transaction center 300.

For instance, the sport match is a baseball match between first and second teams (as shown in FIG. 3; Los Angeles Angels vs. New York Yankees). The information buyer selects the prediction button b3 of the match number 1001 (Los Angeles Angels vs. New York Yankees), inputs “Yankees 10:1 Los Angeles Angels, Yankees win 150$” in the prediction column c2 and the transaction fee column c3 respectively, and presses the entry button b4 for confirmation, thereby transmitting the prediction data and the transaction fee to the website module 24. The transaction center 300 has set out 100$ as the lowest transaction fee for maintenance of fair transaction. Under this condition, the transaction fees demanded by all information sellers are compatible with the lowest transaction fee.

Referring again to FIGS. 1 and 3, when the information buyer, in responding to the sport match broadcasted over the website module 21, operates the second electronic device 12 and transmit a match selection signal and a selection condition data to website module 21.

For instance, the information buyer selects the button b5 representing the match number 1001 (Los Angeles Angels vs. New York Yankees in FIG. 3), thereby transmitting the match selection signal to the website module 21.

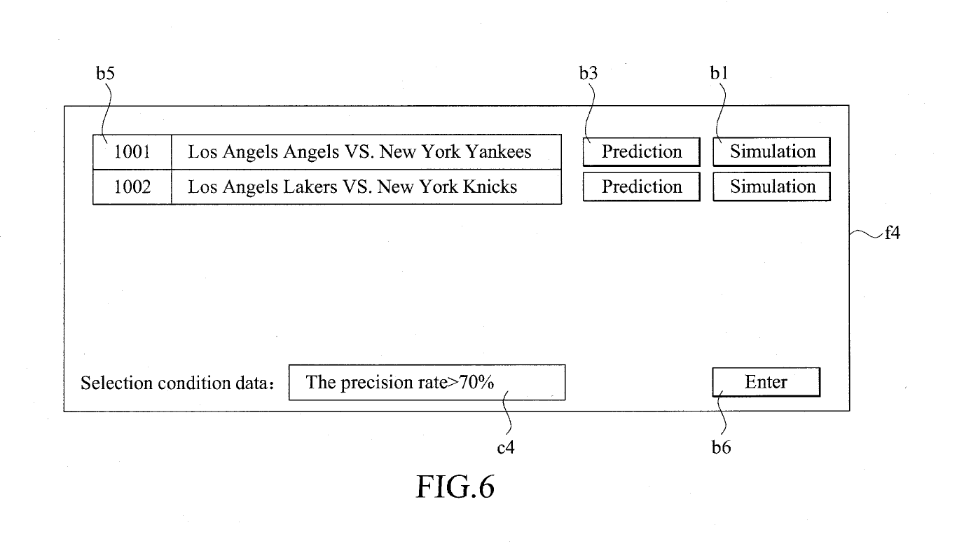

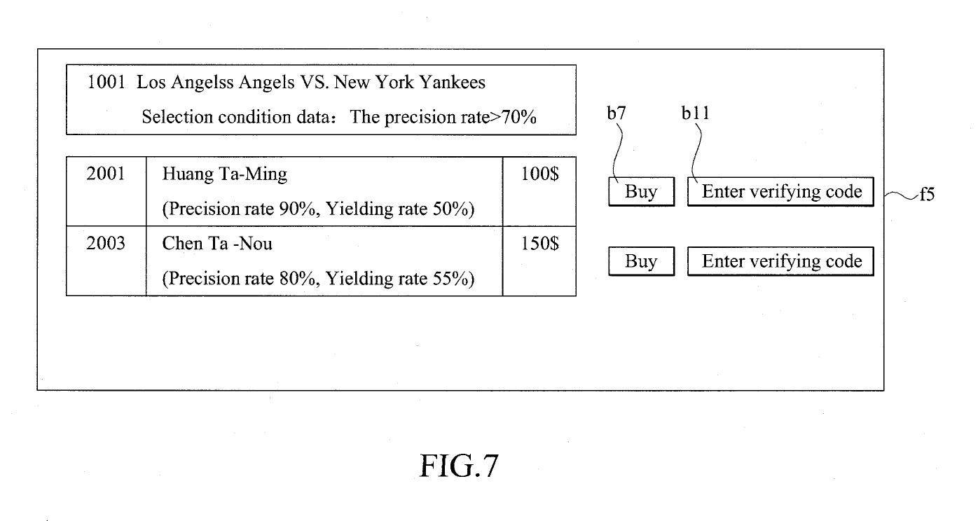

FIG. 6 shows the display screen f4 of the website module, where the sport information buyer presses the button b5 representing the sport match to transmit the selection signal, later he inputs “the selection condition data” and presses the enter button b6, thereby transmitting the selection condition data to website module 21 via the second electronic device 21. The website module 21 transfers the same to the selection module 24, which, upon receipt of the selection condition data, compares the selection condition data and the selection signal relative to the registration data D1 within the data base 27 so as to generate a selection chart f5 as best shown in FIG. 7. The selection chart f5 preferably includes personal data of an individual information seller, the transaction fee, the specific number representing the information seller, and the percentage of betting rate.

For instance, when the information buyer selects the button b5 representing the match number 1001, as best shown in FIG. 6, and inputs one of “the precision rate” “the yielding rate” “the real prediction data” “the real yielding data” “the simulated prediction data” and “the simulated yielding data” into the selection column c4, thereby choosing the desired information seller. In this embodiment, the information buyer inputs “the precision rate >70%” in the selection column c4, and presses the enter button b6 for confirmation, thereby requesting a selection chart including information sellers with “the precision rate >70%”. The selection module 24 generates a selection chart, in response to the input of the information buyer, including two information sellers (represented by the numerals 2001, 2003 respectively) providing the percentage of betting rate greater than “the precision rate >70%”, as best shown in FIG. 7.

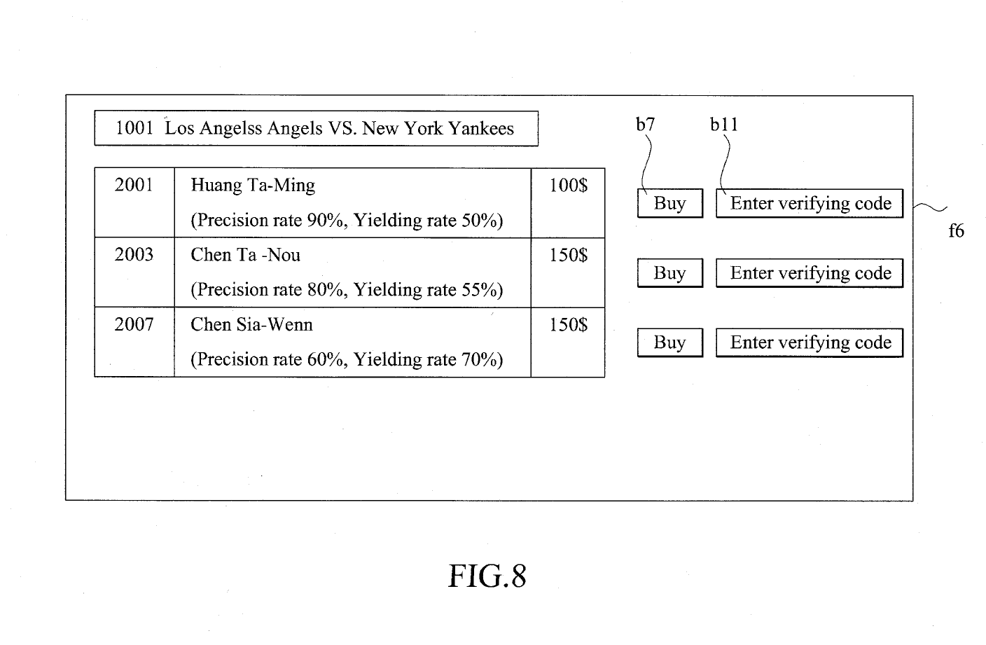

In another embodiment, when the information buyer selects the button b5 representing the match number 1001, as best shown in FIG. 3, and does not input “selection condition data” into the selection column c4 and directly presses the enter button b6 for confirmation. Under this condition, the selection module 24 generates a selection chart, in response to the input of the information buyer. FIG. 8 shows a display screen f6 of the website module illustrating the selection chart or the content on condition that no selection condition data is inputted and illustrating the percentages of betting rate for three information sellers.

For instance, when the information buyer selects the button b5 representing the match number 1001, as best shown in FIG. 3, and directly presses the enter button b6 for confirmation. Under this condition, the selection module 24 generates in response to the input of the information buyer, a selection chart including all the information sellers providing the prediction results respectively. FIG. 8 shows the display screen F6 of the website module illustrating the selection chart including three information sellers represented by 2001, 2003 and 2007 respectively.

The information buyer can operate the second electronic device 12, depending on the selection chart and pressing a buy button b7, to transmit the selection signal to the website module 21, thereby completing the information transaction.

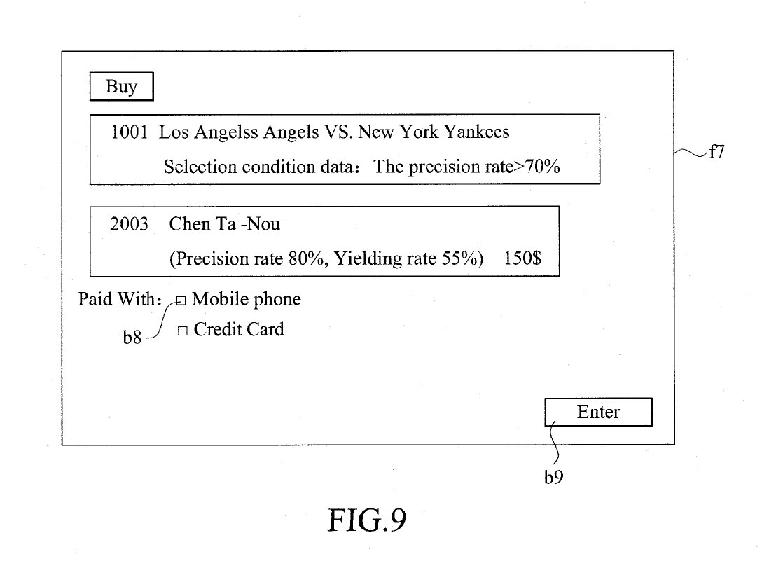

Referring to FIG. 7, when the information buyer selects the number 2003 representing an individual information seller and presses the buy button b7, thereby transmitting the selection signal to the website module 21. In order to prevent untimely and accidentally transmission of the selection signal, the display screen f7 shown in FIG. 9, waits input of entry code to be inserted by the sport information buyer for confirming choosing of the sport match 1001.

The information buyer can pay the transaction fee with the credit card or over the mobile phone. As illustrated in FIG. 9, the information buyer can press the pay button b8 and afterwards press the enter button b9, thereby transmitting the transaction signal to the transaction center 300.

The transaction module 25, upon receipt of the transaction signal, conducts a transaction over the Internet in order to receive paying of the transaction fee from the bank issuing the credit card or the telecommunication firm owning the mobile phone. Since transaction of fee over the Internet is a known art a detailed description thereof is omitted herein for the sake of brevity.

Referring to FIG. 9, wherein a display screen f7 is shown when the information buyer chooses the sport match 1001 and the number 2003 representing a specific information seller. The information buyer is to check the screen to confirm the selection in screen. For making the confirmation, he can press the pay button b8 and later presses the enter button b9 for transmission of the transaction signal to the transaction module 25, which conducts the transaction mentioned in the preceding paragraph.

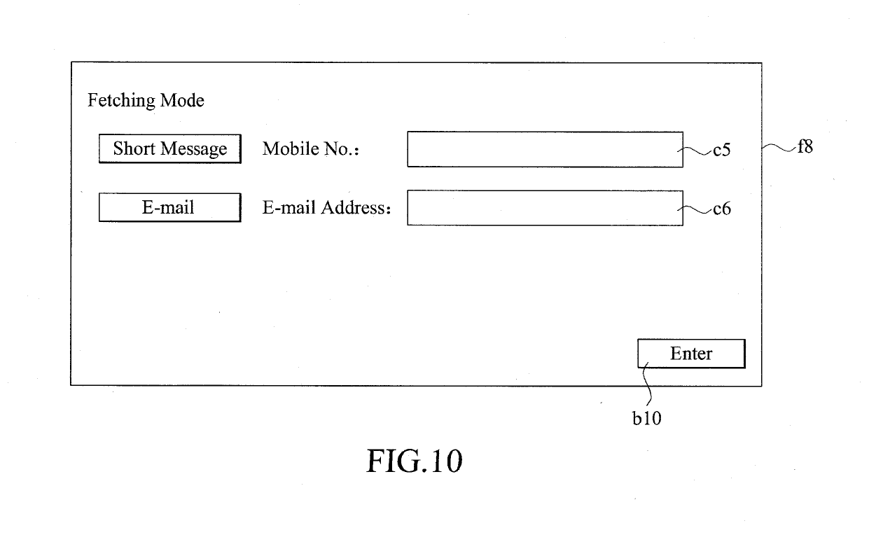

FIG. 10 shows the display screen f8 of the website module illustrating how the information buyer fetches a prediction result of a sport match when the information buyer is not a registered member of the transaction center 300. After transmission of the transaction signal to the website module 21, the information buyer must choose ways of fetching the prediction result. To facilitate communication between the transaction center 300 and the information buyer, the information buyer can input via the second electronic device 12 his e-mail address or mobile phone's no within the e-mail column c5 and phone column c6, and presses the enter button for confirmation. The transaction module 25, after finishing transaction of the transaction fee, generates the verifying code, where, the website module 21 depending on the e-mail address of the information buyer, in turn, transmits the same via the Internet to the second electronic device 12. As to how the transaction module 25 generates the verifying code consisting of string of characters mixing with numbers is known in the art, a detailed description thereof is omitted herein for the sake of brevity.

As shown in FIG. 10, the information buyer can input his e-mail address or mobile phone's no within the e-mail column c5 and phone column c6 respectively, and presses the enter button for confirmation. After finishing transaction of the transaction fee, the transaction module 25 generates the verifying code (such as zxc789456), where, the website module 21 transmits the same via the Internet to the second electronic device 12.

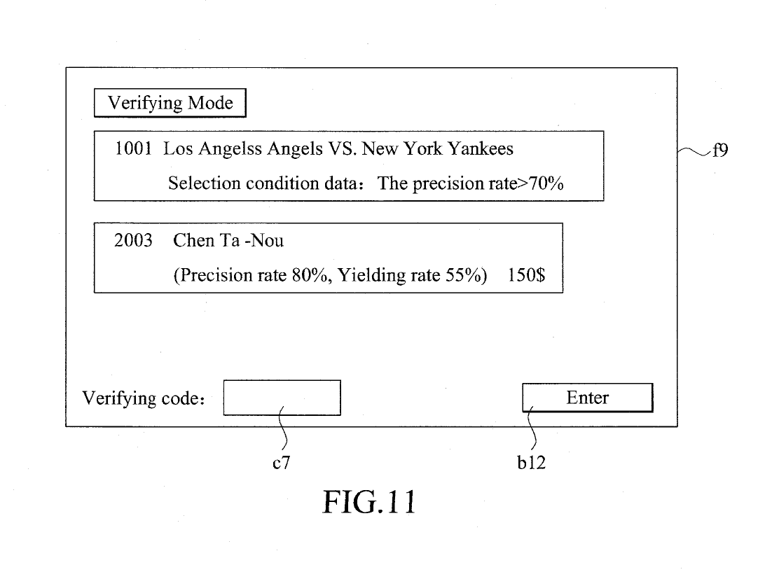

The information buyer, upon receipt of the verifying code, presses the verifying button b11 of the number 2003 representing an individual information seller, as shown in FIG. 7 such that the display screen f9 in FIG. 11 shows a verifying column c7 to allow the information buyer to input the verify code and later the enter button b12, thereby transmitting the verifying code back to the website module 21. Under this condition, the website module 21 transmits the prediction result (see FIG. 5) to the second electronic device 12 via the e-mail address of the information buyer in case the corresponding verifying codes match with each other.

For instance, when the information buyer receives the verifying code via the second electronic device, he is to press the verifying button b11 of the number 2003 representing an individual information seller, as shown in FIG. 7, such that the display screen f9 in FIG. 11 shows the verifying column c7 to allow the information buyer to input the verify code and later the enter button b12, where the verify code is transmitted to the website module 21. When the corresponding codes match with each other, the website module 21 will transmit the predict result to the second electronic device 12 via the e-mail address of the information buyer.

In addition, after finishing transaction of the transaction fee, the transaction center 300 remits a partial amount of the transaction fee to the remittance account of the individual information seller via the Internet 13. Thus, after completing each transaction between the information seller and the information buyer, the transaction center 300 will remit a partial amount of a respective transaction fee to the remittance account of the individual information seller. In one embodiment, the partial amount to be remitted to the remittance account can be accumulated to a preset amount. Upon reaching the preset amount, the transaction center 300 remits via the Internet said preset amount to the to the remittance account of the individual information seller. Since remittance of the accumulated amount via the Internet is known in the art, a detailed description thereof is omitted herein for the sake of brevity.

For instance, when the information seller inserts “150$” into the transaction column c3 and after completing paying of the transaction fee, the transaction center 300 will remit 65% of the transaction fee (i.e. 97.5$) to the remittance account of the individual information seller. In one embodiment, the transaction center 300 defines that the least remittance amount is 1000$, several pieces of the 65% of the transaction fees must be accumulated within the registration data D1 of the information seller to meet the least remittance amount (=1000$).

Referring to FIGS. 7 and 8, note that at a predetermined hour before starting of the sport match, the buy button b6 cannot be pressed since the compiling module 26 must make a final statistic of buying and selling transactions at the transaction center 300.

Upon finishing each sport match, the website module 21 compares the prediction result with the result of the sport match and in case the prediction result matches with the result, the message is transmitted to the compiling module 26, which raises the percentage of betting rate of a respective information seller.

The percentage of betting rate preferably includes a real precision data and a real yielding data. The real precision data is calculated as follows. For instance, the information sellers transmits the prediction data to the transaction center 300 for 5 times, wherein only piece of the prediction data matches with the result of the sport match. Under this condition, the real precision data is (1÷5×100%); i.e., 20% of the real precision rate.

The real yielding data is calculated as follows. Those banks distributing the sport lottery have set out different compensation rates for different types of the lottery. For instance, the bank has announced that if Yankees win (as shown in FIG. 3, Los Angeles Angels vs. New York Yankees), the compensation rate is 1.8; i.e., if the information buyer bets 100$ on the sport match, and if the Yankees win, the information buyer will get 180$. In this embodiment, if the sport seller has transmitted the prediction result to the transaction center 300 for 5 times, wherein only a single piece matches with the result of the sport match. Under this condition, the betting total amount is 500$ and after all the matched are played, he yields a total amount of 180$. Subtracting 500$ from 180$, the real yielding rate of the sport seller r is −64%=(180−500)÷500×100%.

In another embodiment, the precision data of the information seller is calculated as follows. For instance, the information seller has transmitted the simulated prediction result to the transaction center 300 for 10 times, wherein 8 times match with the results of the sport matches respectively. On the other hand, the transaction center 300 has received the prediction result for 5 times but only one piece of the prediction result matches with the result of a respective sport match. Under this condition, the precision data of the information seller is 60%=(1+8)÷(10+5)×100%.

In addition, when the information seller transmits the simulated prediction data and without the prediction results to the transaction center 300 for 10 times, wherein 8 pieces of the simulated prediction data match with the results of the sport matches respectively. In this embodiment, the precision data of the information seller is 80%=8÷10×100%.

Moreover, when the information seller transmits the prediction result and without the simulated prediction data to the transaction center 300 for 5 times, wherein only a single piece matches with the result of a respective sport match. In this embodiment, the precision data of the information seller is 20%=1÷5×100%.

The yielding rate differs from one another depending on the banks distributing the lottery and different types of the sport lottery. For instance, if Angeles Angles win, the compensation rate is 1.8 in the match (Los Angeles Angles vs. New York Yankees). That is if the Los Angeles Angles win, the betting person will get 180$ for 100$. In this embodiment, the information seller has transmitted the simulated prediction result to the transaction center 300 for 10 times, wherein 8 pieces of the simulated prediction result match with the results of the sport matches respectively. Thus, the total betting amount is 1000$ and the yielding amount is 1440$. On the other hand, the transaction center 300 has already received the prediction result for 5 times only one piece matches with the result of a respective sport match. Under this condition, the total betting amount is 500$, the yielding amount is 180$, the accumulated betting amount is 1500$ while the accumulated yielding amount is 1620$. Thus, the yielding rate of the information seller is 8%=(1620−1500)÷1500×100%.

In addition, the information seller has transmitted only the simulated prediction data without the prediction result to the transaction center 300 for 10 times, wherein only 8 pieces of the simulated prediction data match with the results of the sport matches respectively. For instance, the compensation rate is 1.8; i.e., if one bets 100$ on the sport match, and the betting person will get 180$ if he wins. In this embodiment, the betting amount is 1000 and the yielding amount is 1440 such that the yielding rate of the information seller is 44%=(1440−1000)÷1000×100%.

In the event, the information seller has transmitted only the prediction result without the simulated prediction data to the transaction center 300 for 5 times, wherein only one piece of the prediction result matches with the result of the respective sport match. If the compensation rate is 1.8; i.e., if one bets 100$ on the sport match, and the betting person will get 180$ if he wins. In this embodiment, the total betting amount is 500 while the yielding amount is 180 such that the yielding rate of the information seller is −64%=(180−500)÷500×100%.

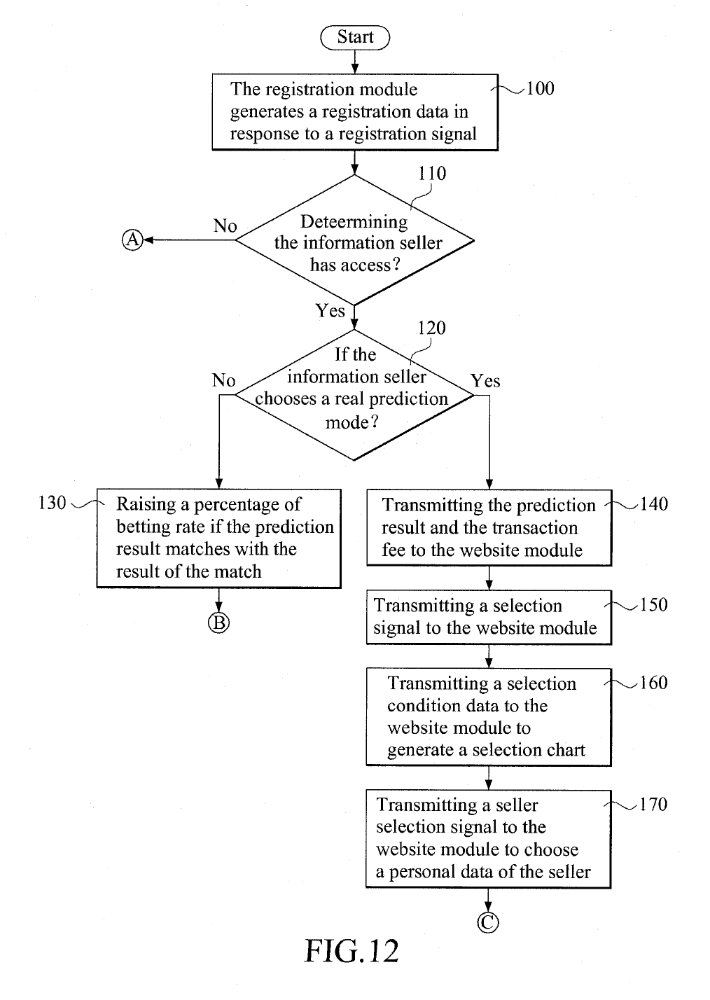

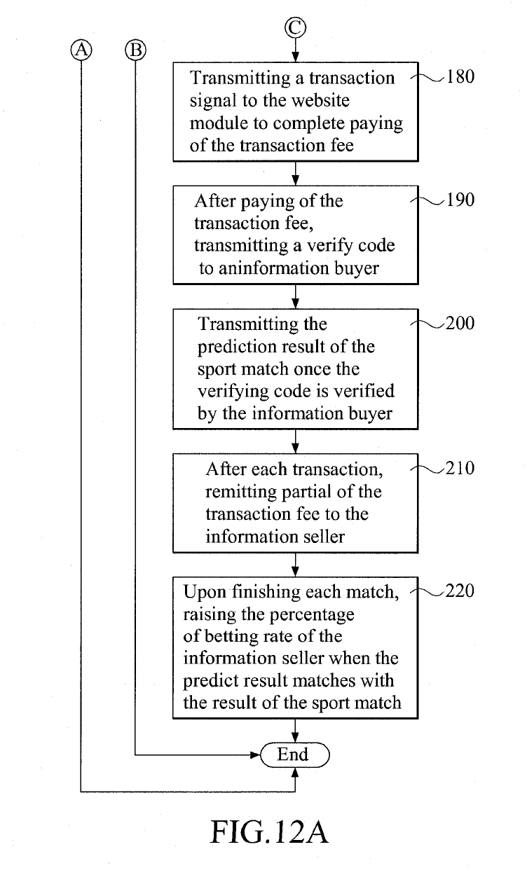

FIGS. 12 and 12A respectively show the block diagram illustrating the steps for a transaction method of the present invention for conducting a transaction fee. Please also see FIG. 2.

The information seller operates the first electronic device 11 to transmit a registration signal S1 to the website module 21, where the registration module 22 generates the registration data D1 in response to the signal S1 (Step 100).

When the information seller transmits an entry signal S2 to access the transaction center 300, the registration module 22 determines whether the entry signal S2 is included within the registration data D1, which includes a coded account, a contact method, a verifying code and a remittance account. After confirmation, the registration module 22 permits access of the information seller to the transaction center 300 (Step 110).

After accessing into the transaction center 300, the website module 21 further determines whether the information seller selects the real prediction mode or a simulated prediction mode (Step 120). In one embodiment, the website module 21, depending on the percentage of betting rate of the information seller, determines whether the information seller selects either the real prediction mode or the simulated prediction mode. In case, the simulated prediction mode has chosen and after completing of the sport match, the simulation module 21 compares the simulated prediction result with the result of the sport match. When the two matches match with each other, the compiling module raises the percentage of betting rate of the information seller (Step 130).

In case, the real prediction mode is chosen, the information seller operating the first electronic device 11 to transmit the prediction result of a sport match broadcasted over the website module 21 and the desired transaction fee to the website module 21 (Step 140).

The information buyer operates a second electronic device 12 to transmit a match selection signal to the website module 21 so as to select the sport match (Step 150).

Upon receipt of the match selection signal, the selection module 24 generates a selection chart which includes personal data of an individual information seller corresponding to the information seller and the transaction fee (Step 160).

The information buyer, depending on the selection chart, operates the second electronic device 12 to transmit a seller-selection signal to the website module 21 in order to choose the personal data of the individual information seller within the selection chart (Step 170).

The information buyer operates the second electronic device 12 to transmit a transaction signal to the website module 21 such that a transaction module 25 conducts a transaction in response to the transaction signal, thereby completing paying the transaction fee (Step 180).

After completing paying the transaction fee, the transaction module 25 generates and transmits a verifying code to the website module 21, which, in turn, transmits the same to the second electronic device 12 (Step 190).

The information buyer operates the second electronic device 12 to transmit a verifying signal to the website module 21, which, in turn, transmits the prediction result of the sport match to the second electronic device 12 (Step 200).

After completing paying the transaction fee, the transaction center remits a partial amount of the transaction fee to said information seller (Step 210).

Upon finishing of the sport match, the sport transaction center 300, depending on a result of said sport match and in case said prediction result matches with said result, using the compiling module 26 to raise percentage of betting rate of said information seller (Step 220).

Because the percentage of betting rate of each information seller is disclosed over the website module, it is relatively easy for the information buyer to determine which match he is to choose. Under this condition, he can input the desired selection condition data and paying the transaction fee to order the website module to supply the prediction result of the coming match.

In addition, for those sport analyzers who have devoted a tremendous effort to conduct the sport analysis, can obtain an appropriate profit in return.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method adapted to be applied in a sport transaction system for transaction of sport information among a sport information seller, a sport information buyer and the transaction system so as to result in paying a transaction fee, the transaction method comprising the steps of:
(a) the information seller, relying on a sport match broadcasted over a website module, operating a first electronic device to transmit a prediction result of said sport match and said transaction fee to said website module;
(b) the information buyer operating a second electronic device to transmit a match selection signal to said website module so as to select said sport match;
(c) said second electronic device transmitting a selection condition data to said website module such that a selection module generates a selection chart depending on said selection condition data, said selection chart including a personal data of an individual information seller and said transaction fee, wherein said individual information seller being corresponding to said information seller;
(d) the information buyer, depending on said selection chart, operating said second electronic device to transmit a seller-selection signal to said website module in order to choose said personal data of said individual information seller within said selection chart;
(e) the information buyer operating said second electronic device to transmit a transaction signal to said website module such that a transaction module conducts a transaction in response to said transaction signal, thereby completing paying said transaction fee;
(f) said website module transmitting said prediction result of said sport match to said second electronic device, hence said information buyer;
(g) said sport transaction system remitting a partial amount of said transaction fee to said information seller; and
(h) upon finishing of said sport match, said sport transaction system, depending on a result of said sport match and in case said prediction result matches with said result, using a compiling module to raise percentage of betting rate of said information seller.

2. The transaction method according to claim 1, further comprising a substep (a1) prior to the step (a): the information seller operating the first electronic device to transmit a registration signal to said website module, which, prepares and generates a registration data in response to said registration signal.

3. The transaction method according to claim 2, wherein said registration data is stored within a data base and includes a coded account, a contact method, a verifying code and a remittance account.

4. The transaction method according to claim 3, further comprising a substep (a2) prior to the step (a): when said information seller enters the sport transaction system using said coded account, said registration module checking whether said coded account is included within said registration data and allowing said information seller to enter the sport transaction system when said coded account is included within said registration data.

5. The transaction method according to claim 1, further comprising a substep (a3) prior to the step (a): said website module determining whether said information seller chooses either a real prediction mode or a simulated prediction mode, the step (a) further comprising a step of choosing said real prediction mode.

6. The transaction method according to claim 5, further comprising a substep (a4) after said substep (a3): said information seller via said first electronic device transmitting a simulated prediction data to a simulation module in case said simulated prediction mode is chosen.

7. The transaction method according to claim 6, further comprising a substep (a5) after said substep (a4): said simulation module, upon finishing of said sport match, comparing said simulated prediction data relative to said prediction result of said sport match and raising said percentage of betting rate of said information seller via said compiling module in case said simulated prediction data matches with said result.

8. The transaction method according to claim 1, further comprising a substep (a3) prior to the step (a): said website module determining, depending on said percentage of betting rate of said information seller, either a real prediction mode or a simulated prediction mode is chosen, the step (a) further comprising a step of choosing said real prediction mode.

9. The transaction method according to claim 1, further comprising a substep (a5) after said substep (a4f3): said information seller via said first electronic device transmitting a simulated prediction data to a simulation module in case said simulated prediction mode is chosen.

10. The transaction method according to claim 9, further comprising a substep (a5) after said substep (a4): said simulation module, upon finishing of said sport match, comparing said simulated prediction data relative to said prediction result of said sport match and raising said percentage of betting rate of said information seller via said compiling module in case said simulated prediction data matches with said prediction result.

11. The transaction method according to claim 7, wherein in said step (c): said selection condition data includes said percentage of betting rate of said information seller, said percentage of betting rate further including a simulated precision data and a simulated yielding data.

12. The transaction method according to claim 1, wherein in said step (e): said completing paying said transaction fee consisting of said information buyer conducting paying of said transaction fee with a credit card or with a mobile phone on line to the sport transaction system.

13. The transaction method according to claim 1, wherein said step (f) further includes a substep (f1): said transaction module generates a verifying code and said website module transmitting said verifying code to said second electronic device.

14. The transaction method according to claim 13, wherein said website module transmits said verifying code to said second electronic device via an e-mail or a mail message over a mobile phone.

15. The transaction method according to claim 13, further comprising a substep (f2) after said substep (f1); said information buyer operating said second electronic device to transmit said verifying code to said website module in order that said website module transmits said prediction result back to said second electronic device.

16. The transaction method according to claim 1, wherein in said (g): said partial amount of said transaction fee is a preset amount.

17. The transaction method according to claim 1, wherein in said (g): said partial amount of said transaction fee is a total amount.

18. The transaction method according to claim 1, wherein in said (h): said percentage of betting rate further includes a real precision data and a real yielding data.

19. A transaction system for conducting transaction of a transaction fee via the Internet which is coupled electrically to a first electronic device and a second electronic device, the transaction system comprising:
a website module for broadcasting a sport match and receiving, prior to beginning of said sport match, a prediction result of said sport match transmitted by a sport information seller via the first electronic device and a match selection signal and a selection condition data transmitted by an information buyer via a second electronic device;
a compiling module coupled electrically to said website module for raising a percentage of betting rate of said information seller when said prediction result matches with a result of said sport match;
a selection module coupled electrically to said website module for generating a selection chart depending on said selection condition data, said selection chart including a personal data of an individual information seller; and
a transaction module coupled electrically to said website module conducting the transaction, thereby completing paying said transaction fee;
wherein, after said information buyer chooses said personal data of said individual information seller within said selection chart, a transaction signal is transmitted to said transaction module for completing paying said transaction fee and said prediction result of said sport match is transmitted to the second electronic device.

20. The transaction system according to claim 19, wherein said selection chart further includes said percentage of betting rate corresponding to said individual information seller, said selection chart being arranged in response of said percentage of betting rate.

21. The transaction system according to claim 19, wherein said percentage of betting rate further includes a precision data such that when said prediction result matches with said result of said sport match, said compiling module raises said percentage of betting rate of said information seller.

22. The transaction system according to claim 19, wherein said percentage of betting rate further includes a yielding data such that when said prediction result matches with said result of said sport match, said compiling module raises a compensation rate of said information seller.

23. The transaction system according to claim 19, wherein said selection chart further includes said transaction fee of said individual information seller, paying said transaction fee consisting of said information buyer conducting paying of said transaction fee with a credit card or with a mobile phone on line to the sport transaction system.

24. The transaction system according to claim 23, wherein upon receipt of said transaction fee, the transaction system remitting a partial amount of said transaction fee to said information seller.

25. The transaction system according to claim 23, wherein upon accumulating a preset amount of said transaction fee, the transaction system remitting said preset amount of said transaction fee to said information seller.

26. The transaction method according to claim 19, wherein after completing transmission of said match selection signal, said transaction module generates a verifying code such that said website module transmits said verifying code to said second electronic device so that said information buyer r can operate said second electronic device to enter into said website module with said verifying code, where said website module transmits said prediction result to said second electronic device.
